(19) United States
(12) Patent Application Publication
(10) Pub. No.: US 2020/0212559 A1
(43) Pub. Date: Jul. 2, 2020

(54) PHASE SCANNING ARRAY ANTENNA AND MOBILE TERMINAL

(71) Applicant: AAC Technologies Pte. Ltd., Singapore city (SG)

(72) Inventors: Yongli Chen, Shenzhen (CN); Jianan Wang, Shenzhen (CN); Xinying Xu, Shenzhen (CN)

(21) Appl. No.: 16/703,816

(22) Filed: Dec. 4, 2019

(30) Foreign Application Priority Data
Dec. 29, 2018 (CN) 201811653024.1

(51) Int. Cl. H01Q 1/50; H01Q 1/48; H01P 3/08; H01Q 3/34

(52) U.S. Cl. CPC H01Q 1/50; H01Q 3/34; H01P 3/081; H01Q 1/48

(57) ABSTRACT

Disclosed are a phase scanning array antenna and a mobile terminal. The phase scanning array antenna includes an antenna layer, a first ground layer, a first transmission layer, a second ground layer, a second transmission layer and a third ground layer arranged in stacks, wherein the antenna layer includes a plurality of antenna elements, the first ground layer, the first transmission layer, the second ground layer, the second transmission layer and the third ground layer form a non-planar Butler feed network feeding power to the antenna layer, the non-planar Butler feed network includes a plurality of input terminals arranged on the second transmission layer and a plurality of output terminals arranged on the first transmission layer, each of the input terminals is electrically connected with each of the output terminals.

### TECHNICAL FIELD

The present disclosure relates to the field of antenna structure technologies for mobile terminals, and more particularly, to a phase scanning array antenna and a mobile terminal.

### BACKGROUND

In order to adapt to the future development of communication industry, certain research and mass production results have been obtained for the Sub 6G small base station. It is our goal to obtain an array with necessary phase scanning results realized, a high gain, a low sidelobe and a wide band, as well as saving costs.

At present, an array antenna needs to use a phase shifter at a front end to realize phase scanning, which needs certain improvement in terms of cost. However, the use of a large number of phase shifters has a certain burden in terms of production cost, and the traditional planar Butler structure is often too large in size and needs an additional transmission line to connect with a feeding place of the array.

### BRIEF DESCRIPTION OF THE DRAWINGS

FIG. 1 is a perspective exploded view of a phase scanning array antenna according to the present disclosure;

FIG. 2 is a perspective diagram of the phase scanning array antenna according to the present disclosure;

FIG. 3 is a sectional view of the phase scanning array antenna along a section A-A in FIG. 2;

FIG. 4 is a partial enlarged diagram of a part B in FIG. 3;

FIG. 5 is a perspective diagram of input terminals and output terminals of a non-planar butler feed network in the phase scanning array antenna according to the present disclosure;

FIG. 6 is a partial enlarged diagram of a part C in FIG. 5; and

FIG. 7 is a distribution diagram of the input terminals and the output terminals of the non-planar Butler feed network according to the present disclosure.

### DETAILED DESCRIPTION

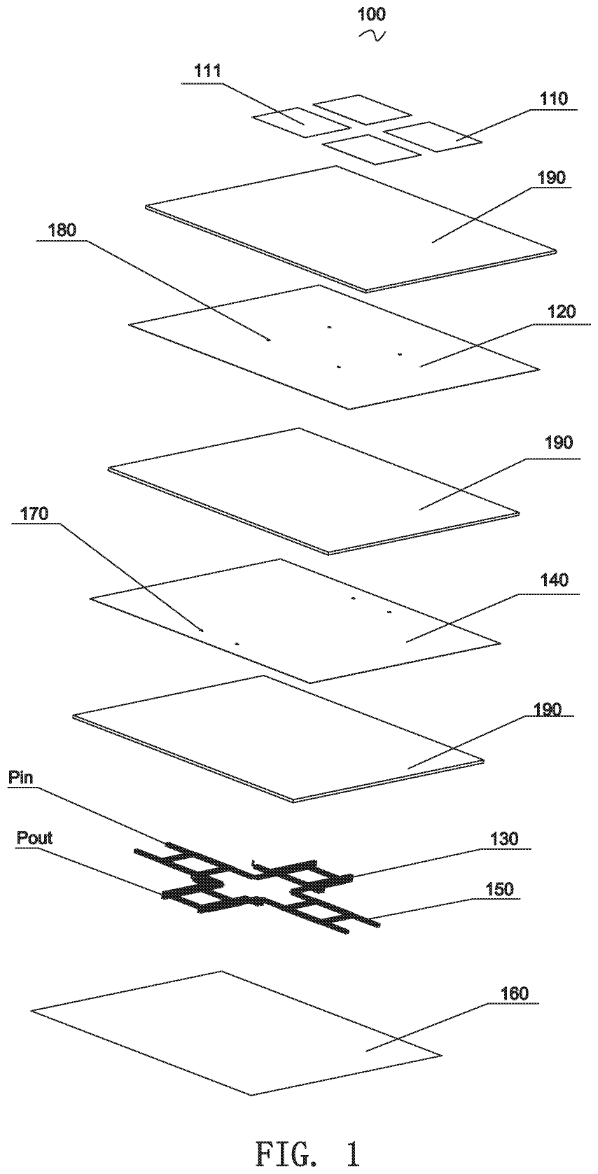

The present disclosure is described in detail hereinafter with reference to FIG. 1 to FIG. 7.

A first aspect of the present disclosure relates to a phase scanning array antenna for a mobile terminal, and the mobile terminal, for example, may be a mobile phone, a computer, a tablet computer or the like. As shown in FIG. 1 to FIG. 4, the phase scanning array antenna 100 includes an antenna layer 110, a first ground layer 120, a first transmission layer 130, a second ground layer 140, a second transmission layer 150 and a third ground layer 160 that are arranged in a stacked manner. The antenna layer 110 includes a plurality of antenna elements 111. The first ground layer 120, the first transmission layer 130, the second ground layer 140, the second transmission layer 150 and the third ground layer 160 form a non-planar Butler feed network feeding power to the antenna layer 110. The non-planar Butler feed network includes a plurality of input terminals Pin arranged on the second transmission layer 150 and a plurality of output terminals Pout arranged on the first transmission layer 130. In other words, the input terminals Pin and the output terminals Pout are not located on the same plane. Each of the input terminals Pin is electrically connected with each of the output terminals Pout, a phase difference between any of the input terminals Pin and each of the output terminals Pout is of an equal difference value, and each of the output terminals Pout is electrically coupled with one of the antenna elements 111.

The phase scanning array antenna 100 in the embodiment includes the non-planar Butler feed network formed by the first ground layer 120, the first transmission layer 130, the second ground layer 140, the second transmission layer 150 and the third ground layer 160, and moreover, the non-planar Butler feed network includes a plurality of the input terminals Pin arranged on the second transmission layer 150 and a plurality of the output terminals Pout arranged on the first transmission layer 130. Each of the input terminals Pin is electrically connected with each of the output terminals Pout_{;} the phase difference between any of the input terminals Pin and each of the output terminals Pout is of the equal difference value, and each of the output terminals Pout is electrically coupled with one of the antenna elements 111. Therefore, in the phase scanning array antenna 100 of the embodiment, positions of array feed terminals can be reasonably arranged, thereby reducing partial loss caused by a transmission line and moreover effectively reducing a volume, so that a structure of the phase scanning array antenna 100 is more compact. In addition, the non-planar Butler feed network can replace a traditional phase shifter for use, thereby reducing the manufacturing cost of the phase scanning array antenna 100.

As shown in FIG. 1 to FIG. 4, the phase scanning array antenna 100 includes a plurality of first through holes 170, and the second transmission layer 150 is electrically connected with the first transmission layer 130 through the corresponding first through hole 170. The phase scanning array antenna 100 further includes a plurality of second through holes 180, and each of the output terminals Pout is electrically connected with the antenna element 111 through the corresponding second through hole 180.

It should be noted that sizes and specific shapes of the first through holes 170 and the second through holes 180 are not limited, and those skilled in the art can define according to actual needs. For example, the first through holes 170 and the second through holes 180 may both be straight through holes, or the first through holes 170 and the second through holes 180 may also be tapered through holes or the like.

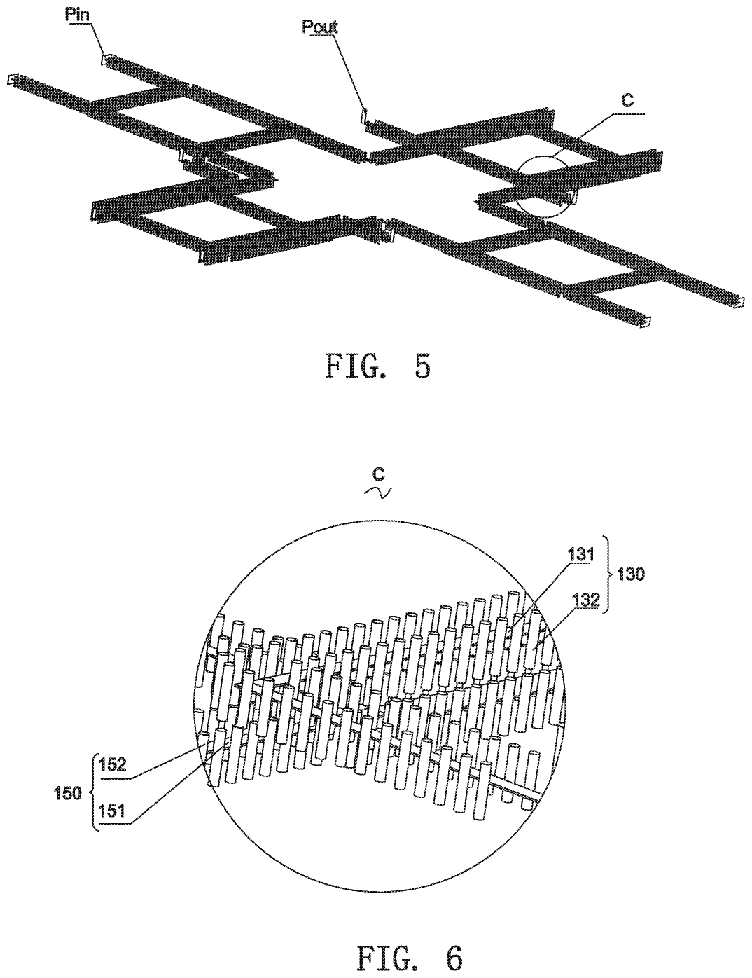

As shown in FIG. 1, FIG. 5 and FIG. 6, the first transmission layer 130 includes a first strip-shaped microstrip line 131, two sides of the first strip-shaped microstrip line 131 are provided with first ground through holes 132 communicated with the first ground layer 120 and the second ground layer 140 to form integrated waveguide. The second transmission layer 150 includes a second strip-shaped microstrip line 151, two sides of the second strip-shaped microstrip line 151 are provided with second ground through holes 152 communicated with the second ground layer 140 and the third ground layer 160 to form integrated waveguide.

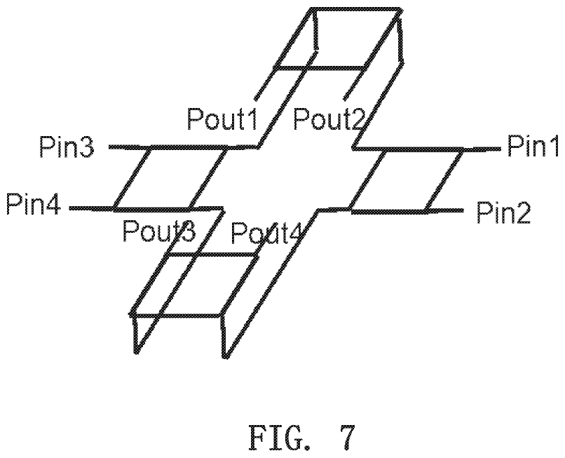

As shown in FIG. 1, FIG. 6 and FIG. 7, the non-planar Butler feed network is arranged in a central symmetry manner. In this way, the positions of the array feed terminals can further be reasonably arranged, thereby reducing partial loss caused by the transmission line and moreover effectively reducing the volume.

Specifically, as shown in FIG. 1, FIG. 6 and FIG. 7, the non-planar Butler feed network includes four input terminals Pin (which are respectively Pin1, Pin2, Pin3 and Pin4) in 2*2 arrangement and four output terminals Pout (which are respectively Pout1, Pout2, Pout3 and Pout4) in 2*2 arrangement, and the antenna elements 111 are arranged in a 2*2 array. Certainly, according to actual needs, those skilled in the art can also design the antenna elements 111 and the non-planar Butler feed networks in arrangements of other numbers, which are not limited here. When one of the input ends Pin, for example, the input end Pin1, operates, phase differences of 0°, 90°, 170° and 90° can be formed at four output ends Pout1, Pout2, Pout3, and Pout4, and the non-planar Butler feed network can replace traditional phase shifters to finally generate four states so as to form phase scanning, thereby reducing the manufacturing cost of the phase scanning array antenna 100. Moreover, the positions of the array feed terminals can further be reasonably arranged, thereby reducing partial loss caused by the transmission line and moreover effectively reducing the volume, so that the structure of the phase scanning array antenna 100 is more compact.

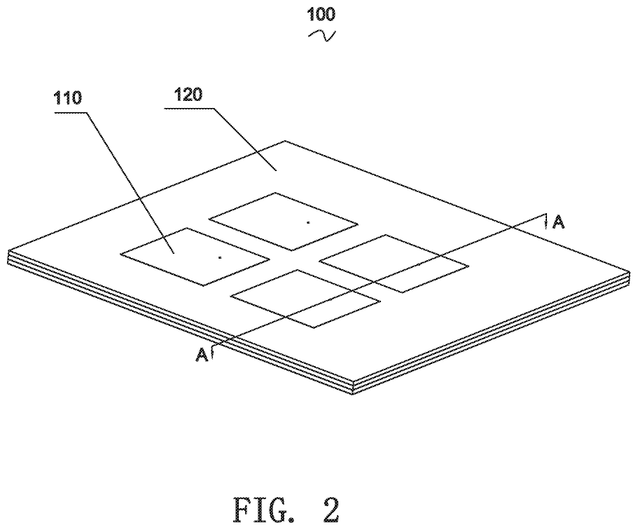

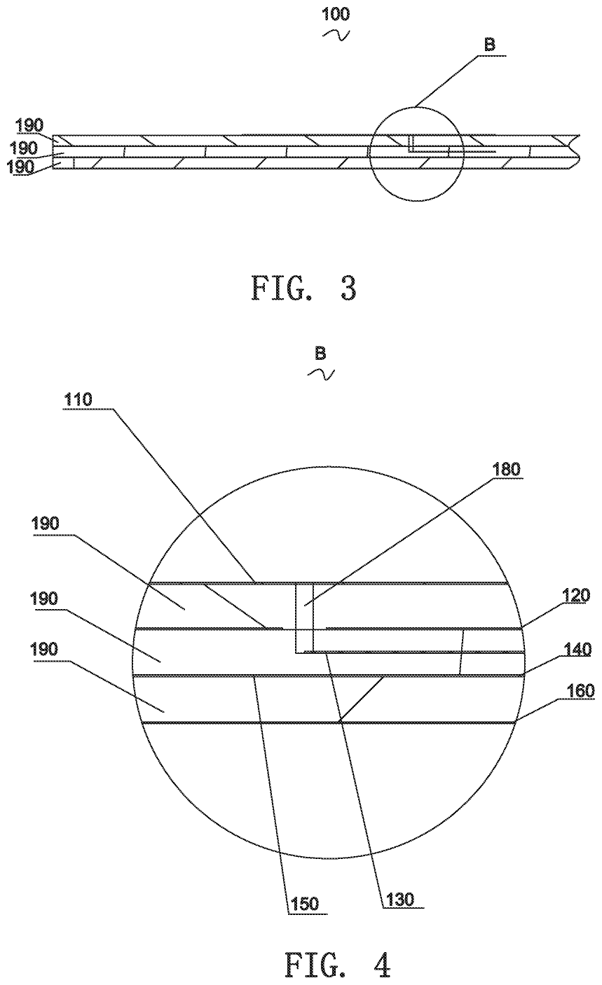

As shown in FIG. 1, FIG. 2 and FIG. 3, the phase scanning array antenna 100 further includes a dielectric plate 190 sandwiched between any adjacent two of the antenna layer 110, the first ground layer 120, the first transmission layer 130, the second ground layer 140, the second transmission layer 150 and the third ground layer 160.

It should be noted that a manufacturing material of the dielectric plate 190 is not limited, and preferably, the dielectric plate 190 may be manufactured by a FR-4 plate. Moreover, a dielectric constant of the dielectric plate 190 can preferably range from 4.2 to 4.4. A loss tangent value of the dielectric plate 190 preferably ranges from 0.015 to 0.035.

A second aspect of the present disclosure provides a mobile terminal employing the phase scanning array antenna 100 above, and a specific structure of the phase scanning array antenna 100 may refer to the related description above, which will not be repeated here.

The mobile terminal with the structure of the embodiment has the phase scanning array antenna 100 above, and the non-planar Butler feed network can replace the traditional phase shifter, thereby reducing the manufacturing cost of the phase scanning array antenna 100. Moreover, the positions of the array feed terminal can further be reasonably arranged, thereby reducing partial loss caused by the transmission line and moreover effectively reducing the volume, so that the structure of the phase scanning array antenna 100 is more compact.

The description above is merely embodiments of the present disclosure, and it should be pointed out that, those of ordinary skills in the art can make improvements without departing from the inventive concept of the present disclosure, but these all belong to the scope of protection of the present disclosure.

What is claimed is:

1. A phase scanning array antenna, comprising:
an antenna layer, a first ground layer, a first transmission layer, a second ground layer, a second transmission layer and a third ground layer that are arranged in a stacked manner;
wherein the antenna layer comprises a plurality of antenna elements;
the first ground layer, the first transmission layer, the second ground layer, the second transmission layer and the third ground layer form a non-planar Butler feed network feeding power to the antenna layer;
the non-planar Butler feed network comprises:
a plurality of input terminals arranged at the second transmission layer; and
a plurality of output terminals arranged at the first transmission layer;
wherein each of the input terminals is electrically connected with each of the output terminals, a phase difference between any of the input terminals and each of the output terminals is of an equal difference value, and each of the output terminals is electrically coupled with one of the antenna elements.

2. The phase scanning array antenna according to claim 1, further comprising a plurality of first through holes;
the second transmission layer is electrically connected with the first transmission layer through a corresponding first through hole.

3. The phase scanning array antenna according to claim 1, further comprising a plurality of second through holes;
each of the output terminals is electrically connected with the antenna elements through a corresponding second through hole.

4. The phase scanning array antenna according to claim 1, wherein the first transmission layer and the second transmission layer respectively comprise strip-shaped microstrip lines, two sides of the first transmission layer are provided with ground through holes communicated with the first ground layer and the second ground layer to form integrated waveguide, and two sides of the second transmission layer are provided with ground through holes communicated with the second ground layer and the third ground layer to form integrated waveguide.

5. The phase scanning array antenna according to claim 1, wherein the non-planar Butler feed network is arranged in a central symmetry manner.

6. The phase scanning array antenna according to claim 2, wherein the non-planar Butler feed network is arranged in a central symmetry manner.

7. The phase scanning array antenna according to claim 3, wherein the non-planar Butler feed network is arranged in a central symmetry manner.

8. The phase scanning array antenna according to claim 4, wherein the non-planar Butler feed network is arranged in a central symmetry manner.

9. The phase scanning array antenna according to claim 5, wherein the non-planar Butler feed network comprises four input terminals in 2*2 arrangement and four output terminals in 2*2 arrangement, and the antenna elements are arranged in a 2*2 array.

10. The phase scanning array antenna according to claim 1, further comprising a dielectric plate sandwiched between any adjacent two of the antenna layer, the first ground layer, the first transmission layer, the second ground layer, the second transmission layer and the third ground layer.

11. A mobile terminal, comprising a phase scanning array antenna, wherein the phase scanning array antenna comprises:
an antenna layer, a first ground layer, a first transmission layer, a second ground layer, a second transmission layer and a third ground layer that are arranged in stacks;
wherein the antenna layer comprises: a plurality of antenna elements;
the first ground layer, the first transmission layer, the second ground layer, the second transmission layer and the third ground layer form a non-planar Butler feed network feeding power to the antenna layer;
the non-planar Butler feed network comprises:
a plurality of input terminals arranged at the second transmission layer; and
a plurality of output terminals arranged at the first transmission layer;
wherein each of the input terminals is electrically connected with each of the output terminals, a phase difference between any of the input terminals and each of the output terminals is of an equal difference value, and each of the output terminals is electrically coupled with one of the antenna elements.

12. The mobile terminal according to claim 11, wherein the phase scanning array antenna comprises a plurality of first through holes;
the second transmission layer is electrically connected with the first transmission layer through a corresponding first through hole.

13. The mobile terminal according to claim 11, wherein the phase scanning array antenna comprises a plurality of second through holes;
each of the output terminals is electrically connected with the antenna elements through a corresponding second through hole.

14. The mobile terminal according to claim 11, wherein the first transmission layer and the second transmission layer respectively comprise strip-shaped microstrip lines, two sides of the first transmission layer are provided with ground through holes communicated with the first ground layer and the second ground layer to form integrated waveguide, and two sides of the second transmission layer are provided with ground through holes communicated with the second ground layer and the third ground layer to form integrated waveguide.

15. The mobile terminal according to claim 11, wherein the non-planar Butler feed network is arranged in a central symmetry manner.

16. The phase scanning array antenna according to claim 12, wherein the non-planar Butler feed network is arranged in a central symmetry manner.

17. The phase scanning array antenna according to claim 13, wherein the non-planar Butler feed network is arranged in a central symmetry manner.

18. The phase scanning array antenna according to claim 14, wherein the non-planar Butler feed network is arranged in a central symmetry manner.

19. The mobile terminal according to claim 15, wherein the non-planar Butler feed network comprises four input terminals in 2*2 arrangement and four output terminals in 2*2 arrangement, and the antenna elements are arranged in a 2*2 array.

20. The mobile terminal according to claim 11, wherein the phase scanning array antenna further comprises a dielectric plate sandwiched between any adjacent two of the antenna layer, the first ground layer, the first transmission layer, the second ground layer, the second transmission layer and the third ground layer.
